(19) United States
(12) Patent Application Publication
(10) Pub. No.: US 2012/0132781 A1
(43) Pub. Date: May 31, 2012

(54) ANTENNA MAST SYSTEM AND MOUNTING APPARATUS

(75) Inventor: Dimitris Kolokotronis, Athen (GR)

(73) Assignee: FASMETRICS LIMITED, Athens (GR)

(21) Appl. No.: 13/379,418

(22) PCT Filed: Jul. 5, 2010
(86) PCT No.: PCT/EP2010/059560

§ 371 Date: Jan. 25, 2012

(30) Foreign Application Priority Data
Oct. 9, 2009 (GB) 0917705.6
Jan. 29, 2010 (EP) 10386003.7

(51) Int. Cl. H01Q 1/12

(52) U.S. Cl. 248/535

(57) ABSTRACT

An antenna mast system (100) comprising a base (102), a plurality of selectively securable modular mast bodies (104), and an antenna mount (106). The base is aligned to a datum and each part of the system is aligned to the base to provide an accurate and repeatable antenna positioning system. The antenna mounting apparatus (106) comprises an antenna mount (138), an intermediate member (158) pivotally attached to the antenna mount to pivot about a first axis (160), an antenna bracket (162) pivotally attached to the intermediate member (158) to pivot about a second axis (164) substantially parallel to the first axis. A control system is used to control the actuation of the system.

The present invention is concerned with an antenna mast system and an antenna mounting apparatus. In particular, the present invention is concerned with an antenna mounting apparatus which provides accurate and flexible azimuth orientation of cellular telephone communication antennas.

Antennas are used for the transmission and reception of electromagnetic signals. Mobile telephone antennas are generally known in the art. For example, U.S. Pat. No. 7,015,871 proposes an assembly of three antennas which can be individually rotated to adjust the coverage in adjacent cells.

Known antennas and antenna constructions need to be as compact as possible for aesthetic reasons and spatial requirements. Therefore, as in U.S. Pat. No. 7,015,871, the antennas are positioned close together, and equally spaced around a central axis.

A disadvantage of such antenna assemblies is that the adjustment of azimuth of each antenna is limited to approximately 15 degrees in each direction (left or right). This is due to the proximity of the antennas. As such, if three antennas are 120 degrees apart, the azimuth range between two adjacent antennas is between 90 and 150 degrees (i.e. 120 degrees plus or minus 15 degrees per antenna). This limits the ability of the antenna to be used in modern networks. Almost all modern networks operate in tandem, and are frequently expanded to meet higher capacity and data rate requirements, whilst reducing coverage problems and limitations on coverage resulting from interference. Further, it is now desirable to provide two adjacent antennas which can point in the same direction.

Cellular telephone antennas may be mast mounted, in which case a mast is installed in a desired position by a mast manufacturer, and the antenna is subsequently mounted to the mast and adjusted to the desired orientation (i.e. azimuth and tilt). Traditionally, three antennas are mounted to a mast, pointing in different directions. The azimuth of each antenna is set up manually using tools such as the Katherein™ azimuth adjustment tool, which uses a telescope attached to a frame to manually position the antenna based on a target. This requires a provider to have a technician at the antenna to manually manipulate it.

This method of orientation of the antennas once mounted on the mast is not very accurate, and results in a significant degree of error. The result of inaccurate azimuth alignment in cellular networks is either excessive sector overlap (i.e. excessive overlap of adjacent antenna coverage), or gaps between adjacent sectors. Both are undesirable due to spectrum efficiency, network performance and antenna roll-out costs.

What is required is an antenna mast and mounting system which provides a high degree of installed antenna accuracy, without requiring manual adjustment in-situ and which provides accurate antenna azimuth adjustability for future configurations.

If more than one service provider (e.g. mobile telephony company) wishes to share an antenna site with another service provider, the current state of the art offers several solutions. The preferred solution is to provide site-sharing capability within the antenna technology. This means that transmission and reception of electromagnetic signals from both providers is sent and received from a single antenna. This is disadvantageous because the position of the antenna (both azimuth and tilt) which benefit one provider, may be detrimental to the other provider. Therefore the usual solution is to adopt an intermediate position for both providers which is not optimal for either.

Similarly, if one service provider wants to transmit 2 different radio access technologies (RATs) from a single location, transmitting them from a single antenna is often not the optimal solution. This is because the antenna has a single azimuth and tilt. Therefore both RATs will have a very similar footprint. This effect poses serious problems when it comes to network dimensioning, optimization and performance management, since, for example, different RATs such as time division multiple access (TDMA), wideband code division multiple Access (WCDMA) and orthogonal frequency-division multiple access (OFDMA) entail different radio propagation and resource management characteristics. Additionally, the use of common antennas directly results in transmitted power reduction for each RAT, causing cell coverage and handover areas to shrink. This is undesirable.

Known antenna masts and mounting systems with azimuth adjustment capability are generally limited to a specific type of antenna having fixed dimensions (width, depth, height) and electrical characteristics. This constrains the provider in their selection of an antenna which is compatible with the mast and mounting system. This is undesirable as the provider is unable to select the best antenna for the application.

A further drawback of prior art antenna mast arrangements is that different masts need to be manufactured for different locations (e.g. urban, suburban and rural), i.e. known masts are application specific. For example, in urban applications, masts are installed on the top of buildings and as such may only be about 8 m in height, where the desired range of coverage is 500 m to 3 km. Guided wire masts are used for suburban applications where the mast height is up to 18 m and the range of coverage is 2 km to 10 km. Very tall masts are required for applications where the mounting surface is far away from the proposed position of the antenna (e.g. in remote, rural areas where the mounting surface may be the ground). The height may be up to 50 m, and the range of coverage from 10 km to 20 km.

It is an aim of the present invention to overcome, or at least mitigate, one or more of the above mentioned disadvantages.

According to a first aspect of the invention there is provided a cellular communications antenna mounting apparatus comprising; an antenna mount, an intermediate member pivotally attached to the antenna mount to pivot about a first axis, an antenna bracket pivotally attached to the intermediate member to pivot about a second axis substantially parallel to the first axis.

By providing such an arrangement, the antenna direction and position can be better adjusted, to the extent that in a given space envelope two antennas can be pointed in the same direction.

The antenna mounting apparatus may comprise a first actuator configured to pivot the intermediate member about the first axis relative to the antenna mount, and a second actuator configured to pivot the antenna about the second axis relative to the intermediate member.

Preferably the first actuator comprises a rotary output shaft oriented perpendicular to the first axis, the apparatus comprises a gearbox between the rotary output shaft and the intermediate member to transfer drive from the rotary shaft to the intermediate member.

Preferably the second actuator comprises a rotary output shaft oriented perpendicular to the second axis, the apparatus comprising a gearbox between the rotary output shaft and the antenna to transfer drive from the rotary shaft to the antenna.

Preferably the gearbox comprises a worm gear, in which the worm gear is connected to the rotary output shaft and drives a bevel gear connected to the intermediate member and/or antenna. Advantageously, the worm gear cannot be easily back driven.

Preferably the actuator is a stepper motor. Therefore more accurate position of the antenna can be achieved. Preferably the stepper motor has a built-in optical encoder.

Preferably the mast comprises an electrical potentiometer arranged to monitor the position of the antenna.

According to a second aspect of the present invention there is provided a cellular communications antenna mast system comprising: a base, at least one mast component, and, an antenna mounting system, in which the at least one mast component comprises alignment means configured to align the at least one mast component with the base in a predetermined angular orientation about a main mast axis, and, in which the antenna mounting system comprises alignment means configured to align the antenna mount with the at least one mast component in a predetermined angular orientation about the main mast axis, such that upon assembly of the antenna mast system, the antenna mounting system is aligned with the base in a predetermined angular orientation such that the alignment of the base with a datum point is transferred to the antenna mount.

According to a third aspect of the present invention there is provided a method of installing a cellular communications antenna mast comprising the steps of:
providing a base,
providing at least one mast component and
providing an antenna mount,
aligning the base to a datum,
assembling the at least one mast component to the base in a predetermined orientation with respect to the base,
assembling the antenna mount to the at least one mast component in a predetermined orientation with respect to the at least one mast component, such that the antenna mount is oriented in a predetermined orientation with respect to the datum.

By aligning each of the components of the mast to the base, which is aligned to the datum (e.g. North), the antennas can be subsequently be installed on the mast by a provider without the need to manually calibrate them. The provider will know exactly in which direction the antennas face, and can adjust them appropriately to the desired direction using e.g. a mounting apparatus according to the first aspect.

According to a fourth aspect of the present invention there is provided a cellular communications antenna mast comprising: a first antenna mounting structure comprising a first antenna receiving formation, a second antenna mounting structure comprising a second antenna receiving formation, in which the first mounting structure and second mounting structure are arranged to be vertically spaced in use, and in which the first and second antenna receiving formations are independently operable to independently adjust the position of the first and second antenna receiving formations.

The two sets of antennas can be used to transmit and receive different types of signals as well as signals from different providers at the same site, and their independent adjustability permits the optimum orientation for both signal types and/or providers.

According to a fifth aspect of the present invention there is provided an antenna mast system comprising: a base, a plurality of modular mast components, an antenna mount, wherein the plurality of modular mast components are selectively securable together in a variety of different configurations to provide an installer-selectable distance between the base and the antenna mount.

According to a sixth aspect of the present invention there is provided a method of installing an antenna mast comprising the steps of:
providing a base,
providing an antenna mount,
providing a plurality of modular mast components,
selecting a number of modular mast components from the plurality,
securing the number of modular mast components together between the antenna mount and the base to provide a desired distance there between.

The first and second securing members can be manually actuable.

There is also provided an antenna assembly having a central antenna mount having a plurality of antenna mounting apparatuses according to the first aspect attached thereto. Preferably three antenna mounting apparatuses according to the first aspect are attached thereto.

Advantageously, the provision of complimentary mounting formations on the mast body mean that more than one mast bodies can be stacked in a modular fashion to provide the necessary height of mast. Provided with a given installation requirement, the mast can be adapted and installed to meet that requirement. The installer needs only to hold the three part types in stock, and the installation requirement will determine the number of mast bodies to be used.

The first and second attachment formations can be different. Alternatively, the first and second attachment formations can be the same.

The first attachment formation can be shaped to be able to receive the second attachment formation.

Preferably the base comprises a base body defining a surface contact plane and a mast mount, the first attachment formation is configured to engage the mast mount, and the mast mount is pivotally attached to the base body to rotate the mast body between a stowed position and an erect position substantially perpendicular to the surface contact plane. In this manner, erection of the mast is made easier.

Preferably the mast body comprises a first flange and a second flange connected by a truss framework, wherein the first attachment formation is defined on the first flange and the second attachment formation is defined on the second flange.

An example antenna mast and mount according to the present invention will now be described with reference to the accompanying figures in which:

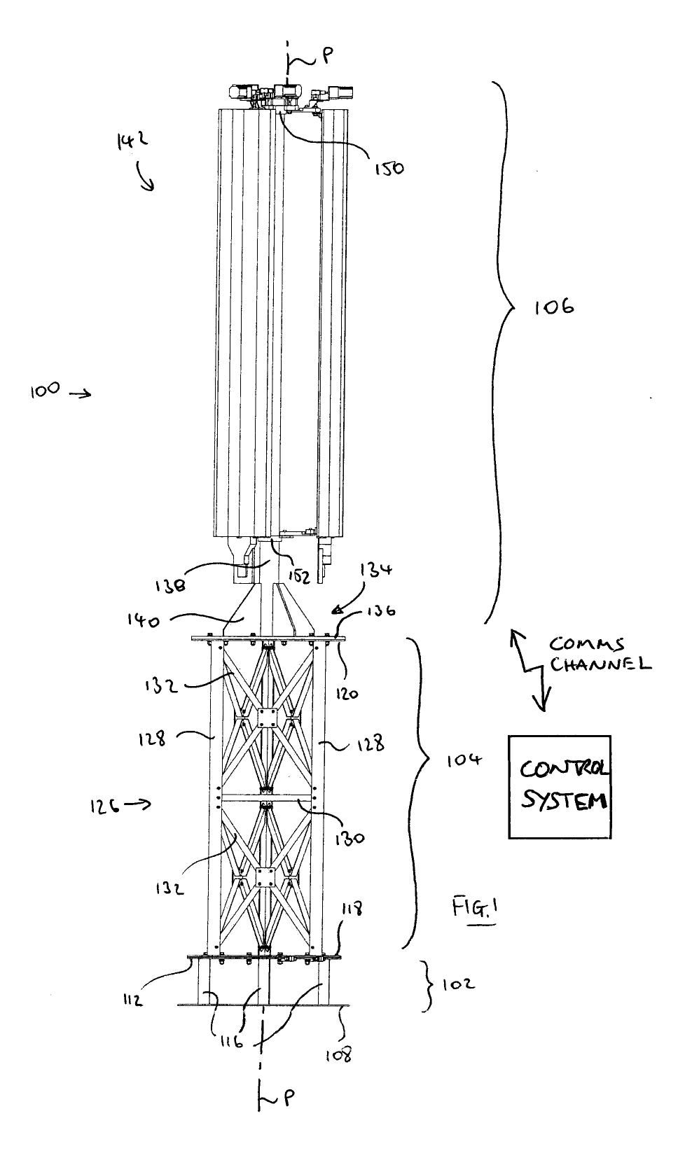

FIG. 1 is a side view of an antenna mast and mounting apparatus in accordance with the present invention;

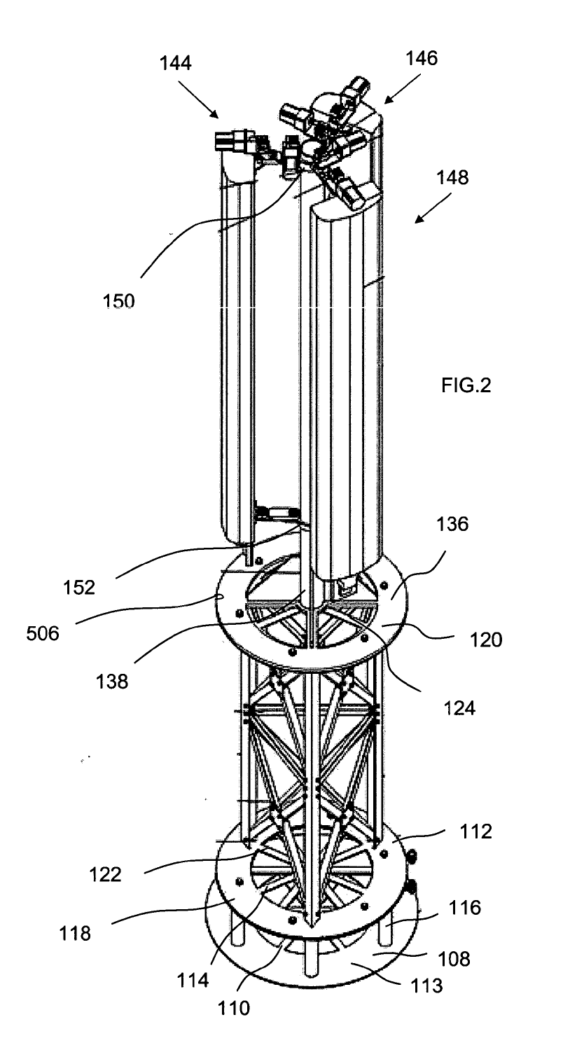

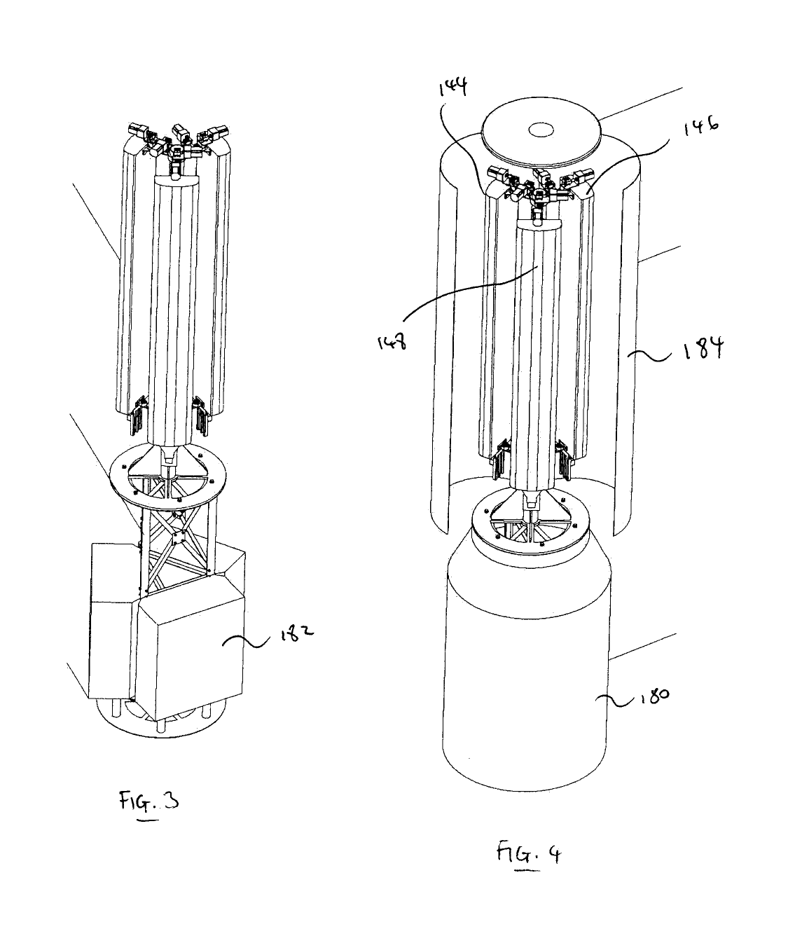

FIG. 2 is a perspective view of the antenna mast and mounting apparatus of FIG. 1;

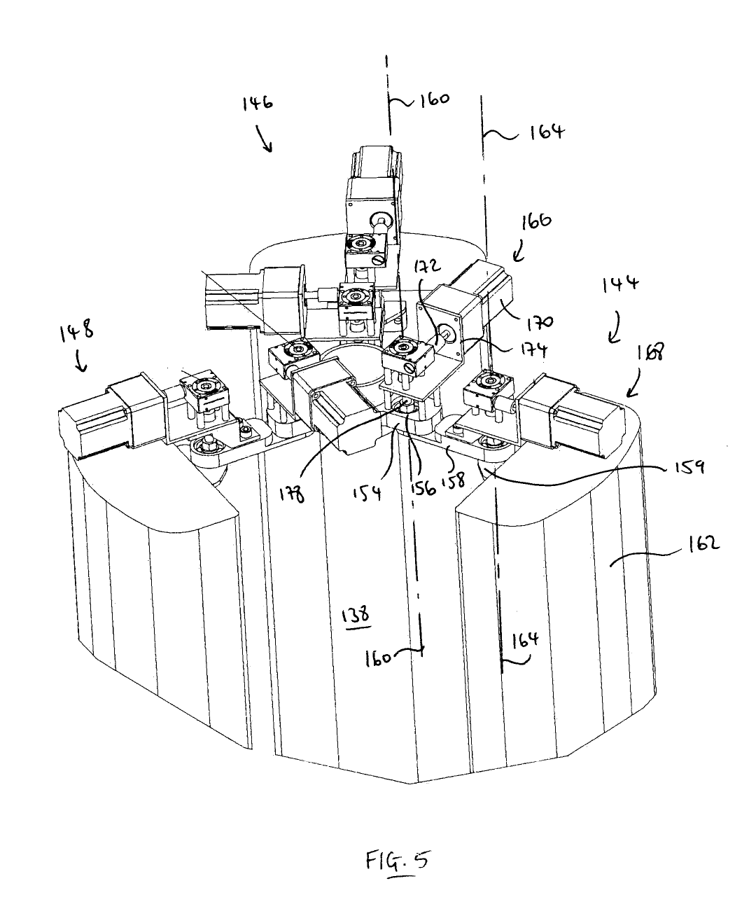

FIG. 3 is a perspective view of the antenna mast and mounting apparatus of FIG. 1;

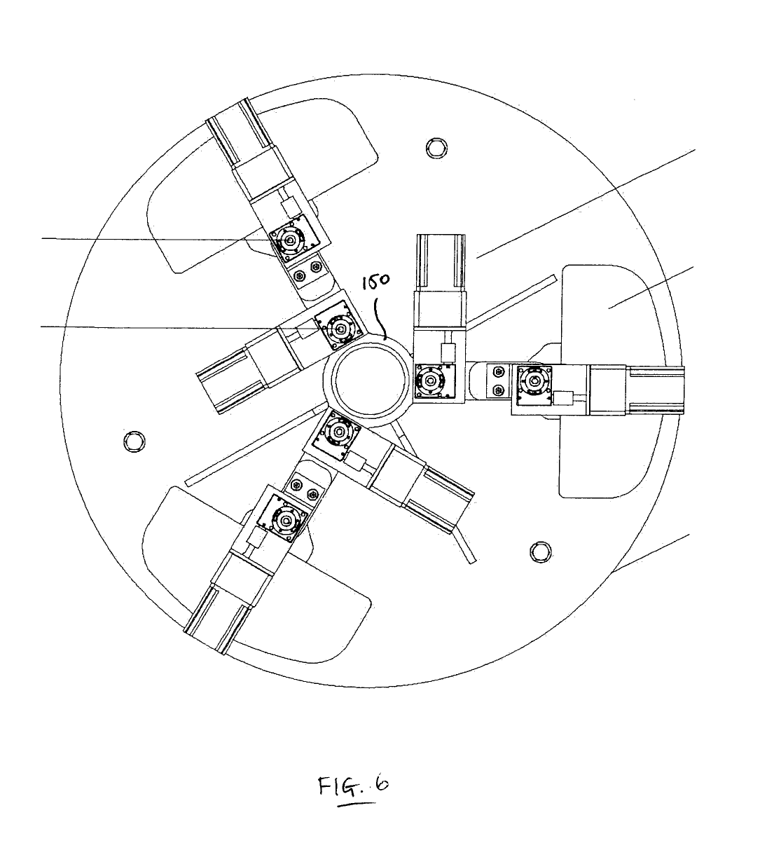

FIG. 4 is a perspective view of the antenna mast and mounting apparatus of FIG. 1 with additional componentry shown;

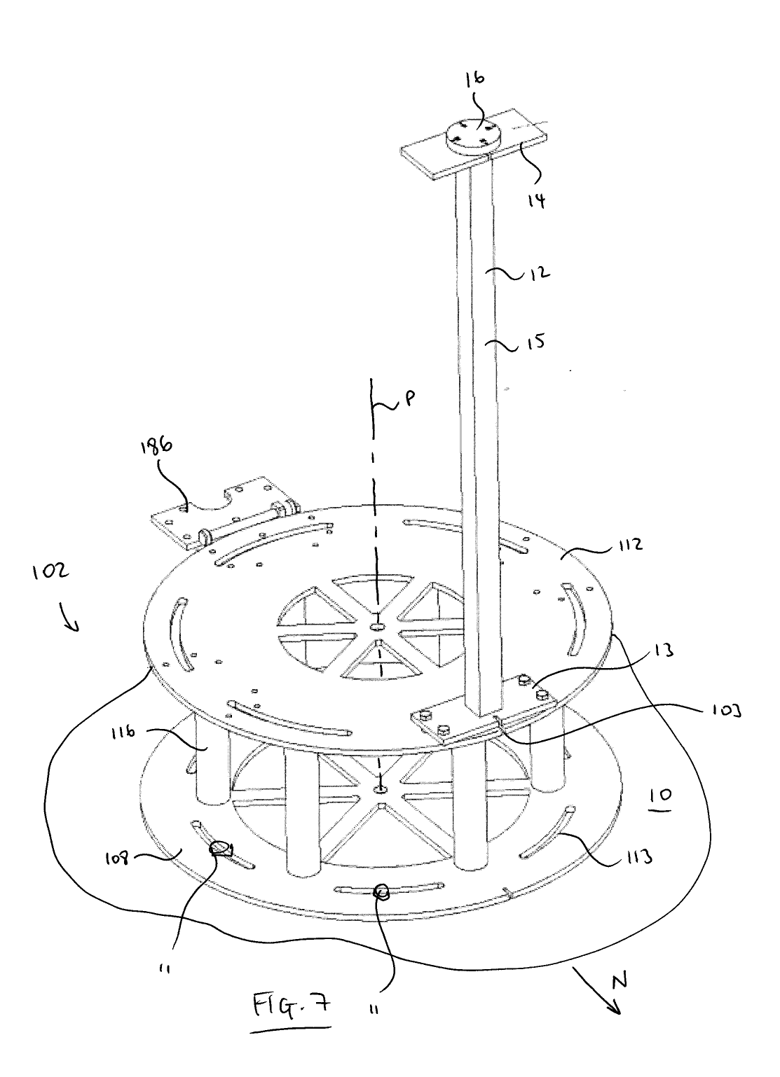

FIG. 5 is a perspective view of a part of the antenna mast and mounting apparatus of FIG. 1;

FIG. 6 is a plan view of the antenna mast and mounting apparatus of FIG. 1;

FIG. 7 is a perspective view of a first stage of assembly of the antenna mast and mounting apparatus of FIG. 1;

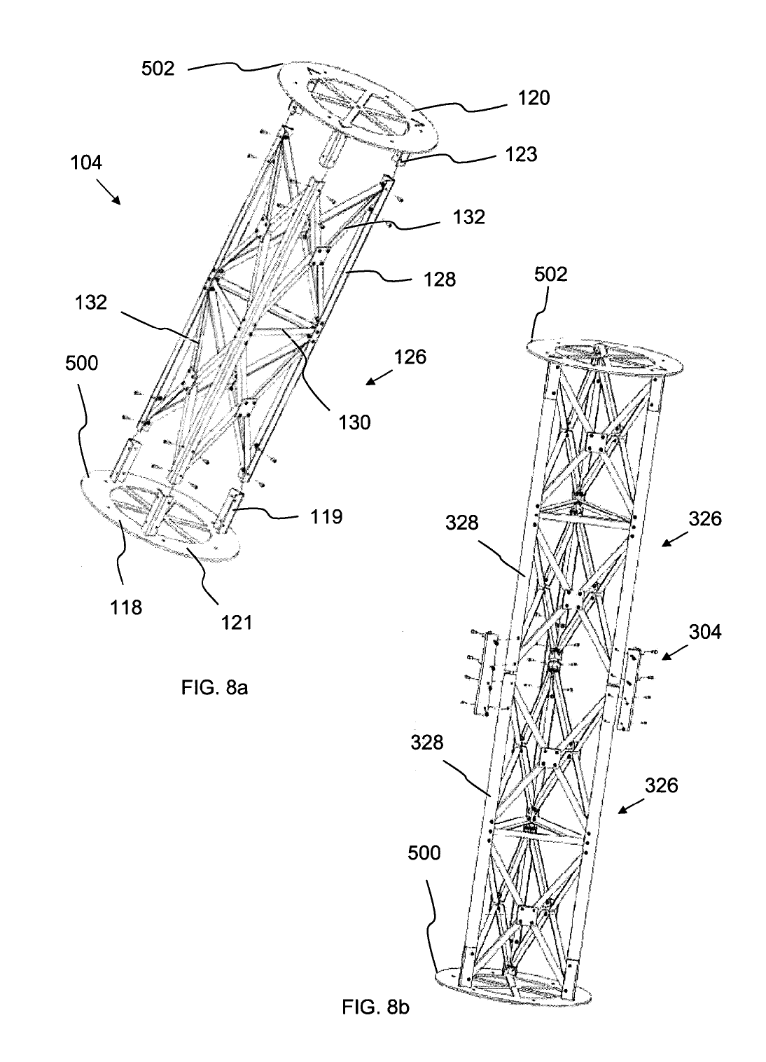

FIG. 8a is a perspective exploded view of a part of the antenna mast and mounting apparatus of FIG. 1;

FIG. 8b is a perspective exploded view of an alternative arrangement of the part of FIG. 3;

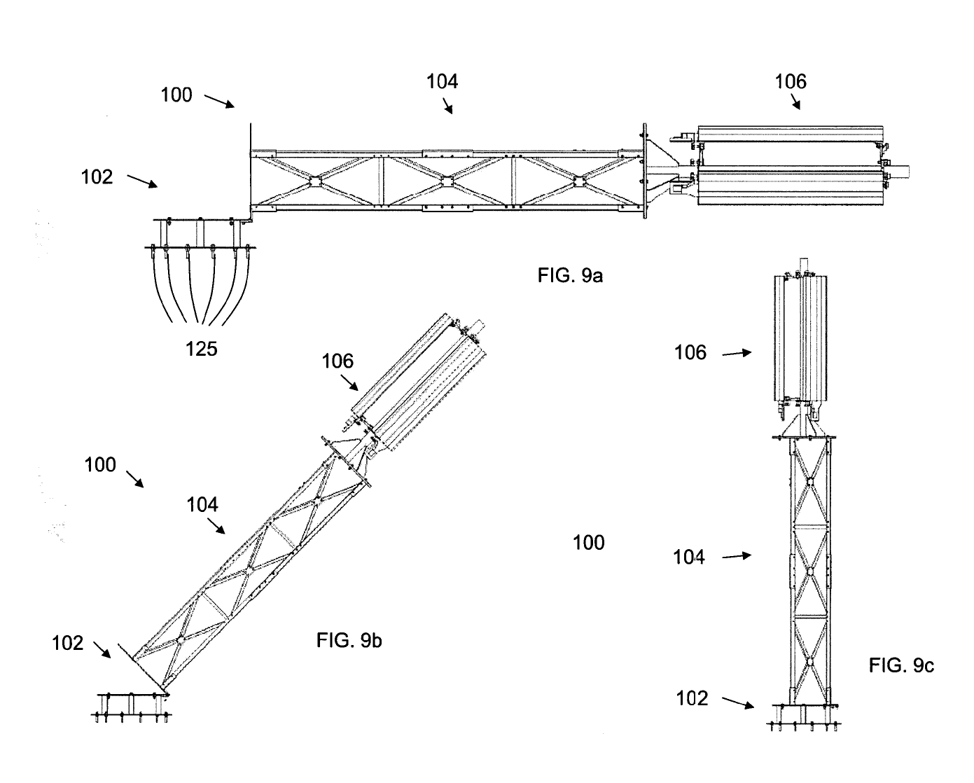

FIG. 9a is a side view of the antenna mast and mounting apparatus of FIG. 1 in an assembly position,

FIG. 9b is a side view of the antenna mast and mounting apparatus of FIG. 1 in an intermediate position,

FIG. 9c is a side view of the antenna mast and mounting apparatus of FIG. 1 in an erected position,

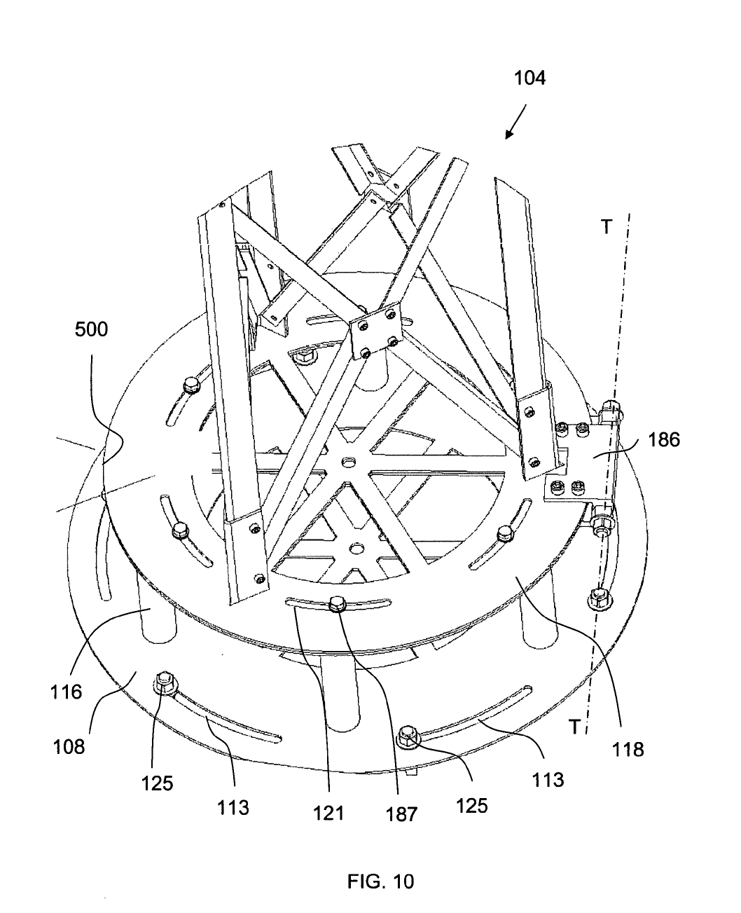

FIG. 10 is a detail view of a part of the antenna mast and mounting apparatus of FIG. 1 in an erected position,

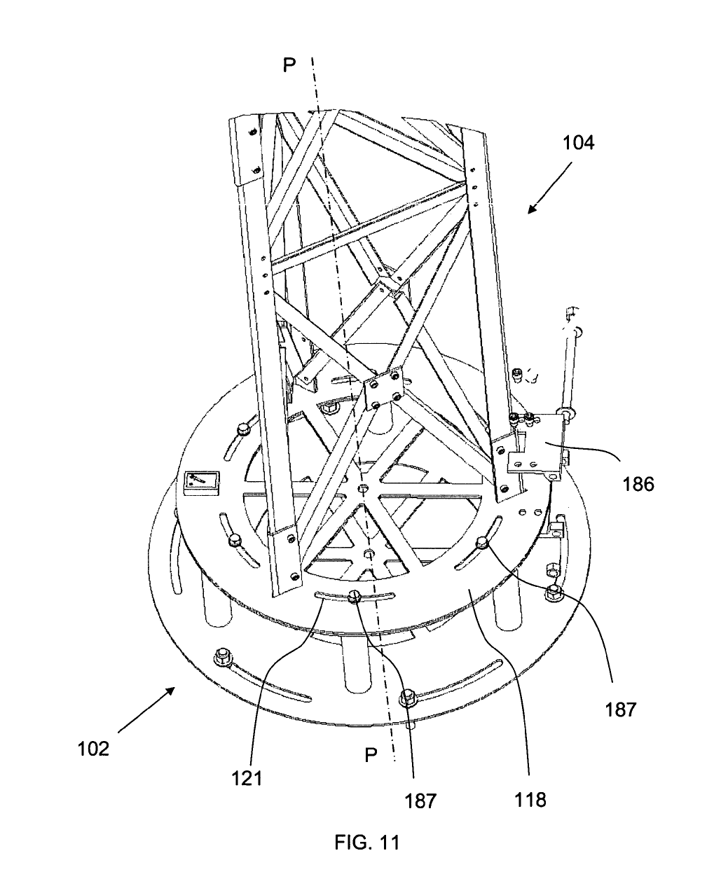

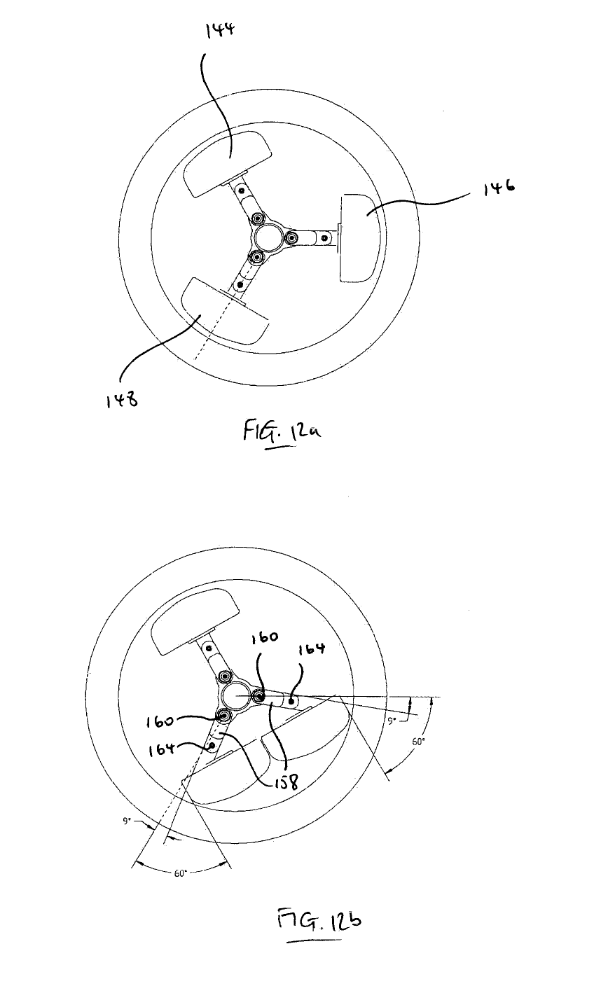

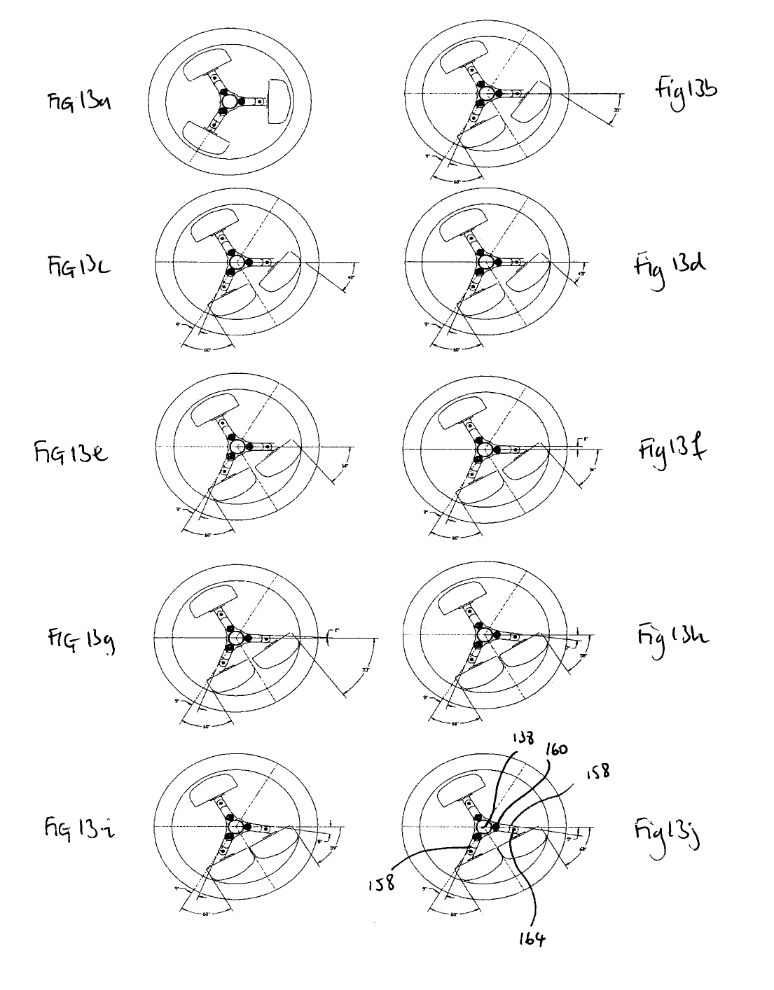

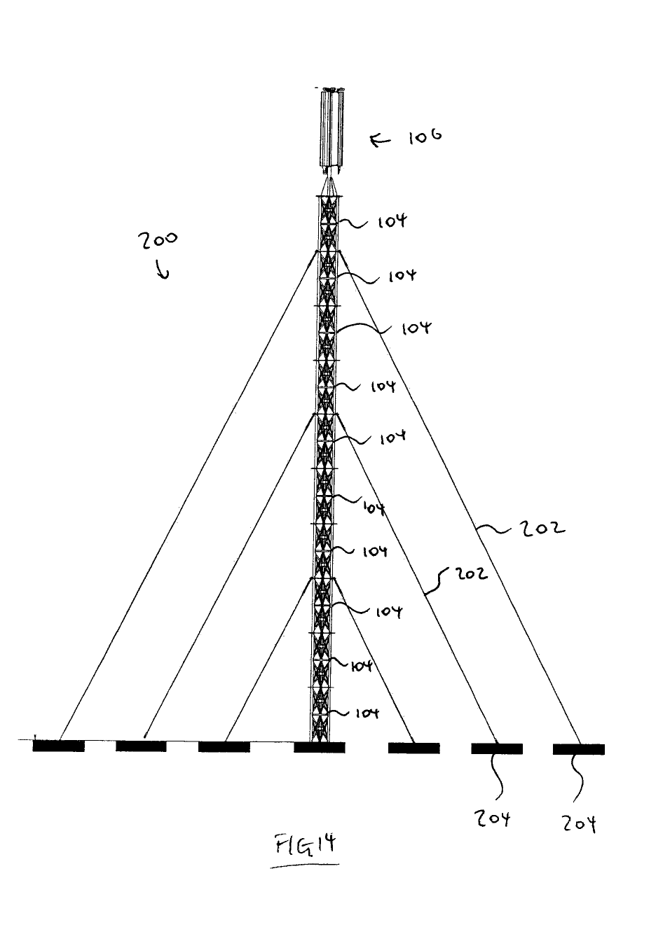

FIG. 11 is a detail view of a part of the antenna mast and mounting apparatus of FIG. 1 with some components in the process of being removed,

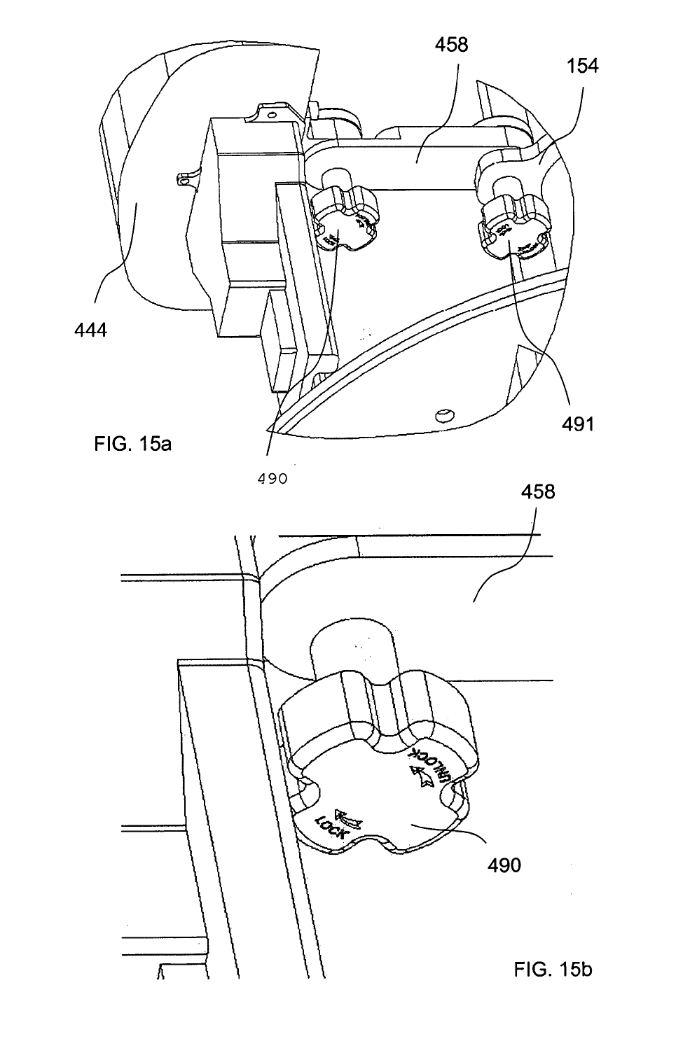

FIG. 12a is a plan view of the antenna mast and mounting apparatus of FIG. 1 in a first configuration;

FIG. 12b is a plan view of the antenna mast and mounting apparatus of FIG. 1 in a second configuration;

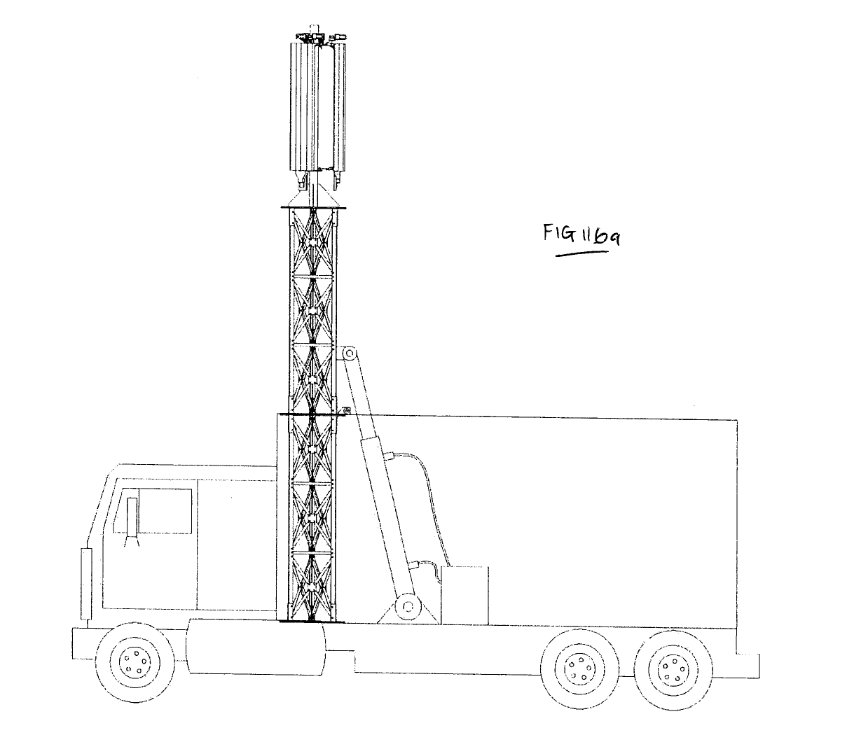

FIGS. 13a to 13j are plan views of the antenna mast and mounting apparatus of FIG. 1 in various transition stages between the first condition of FIG. 7a and the second condition of FIG. 7b;

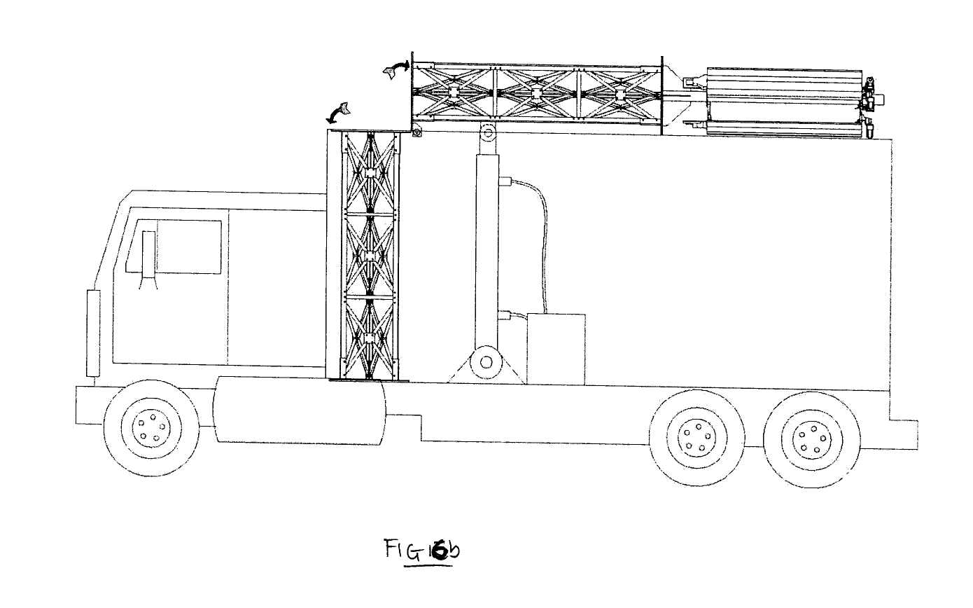

FIG. 14 is a side view of a second antenna mast and mounting apparatus in accordance with the present invention;

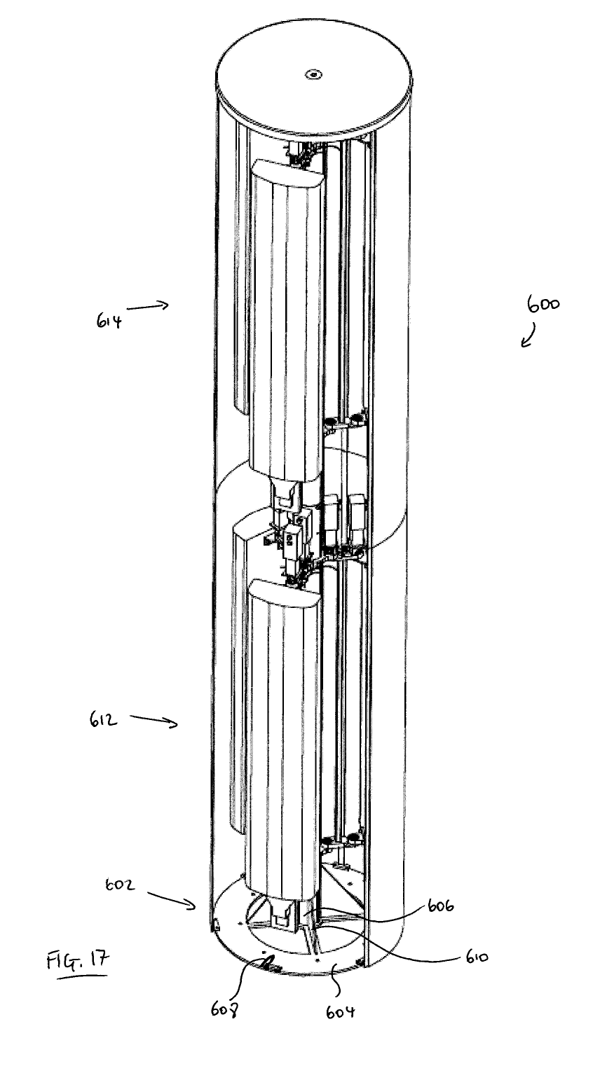

FIG. 15a is a perspective view of an alternative antenna actuation system;

FIG. 15b is a detail view of the system of FIG. 14a;

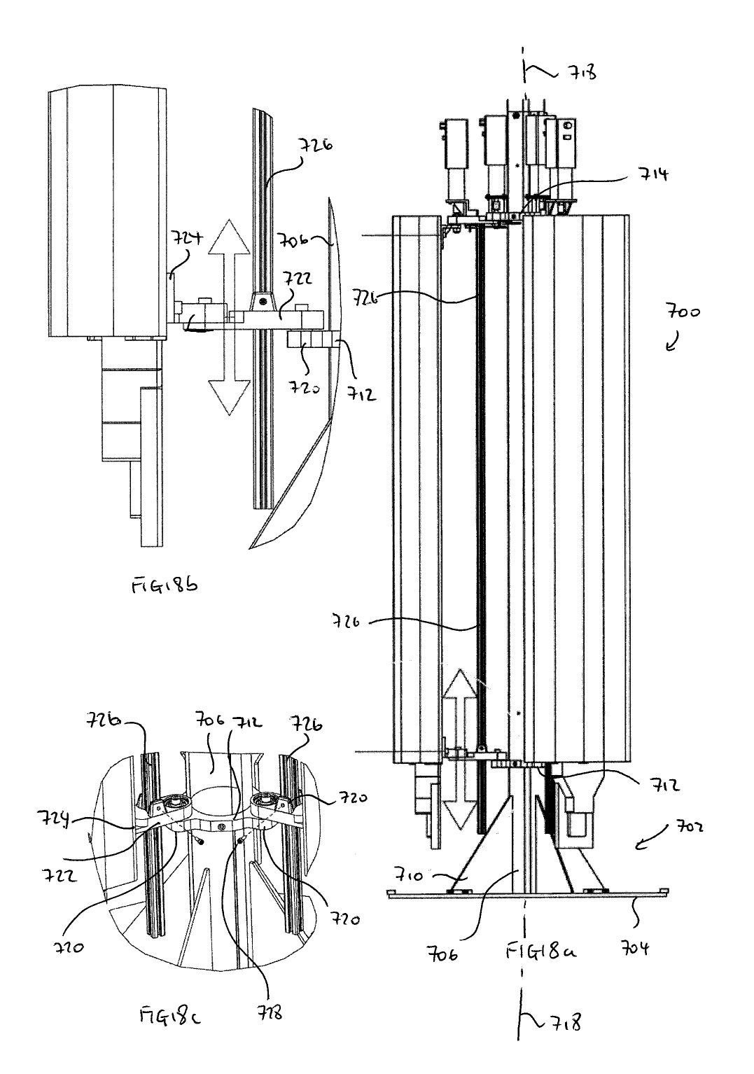

FIG. 16a is a side section view of a vehicle carrying a mast according to the invention;

FIG. 16b is a side section view of a vehicle carrying a mast according to the invention in a stowed condition;

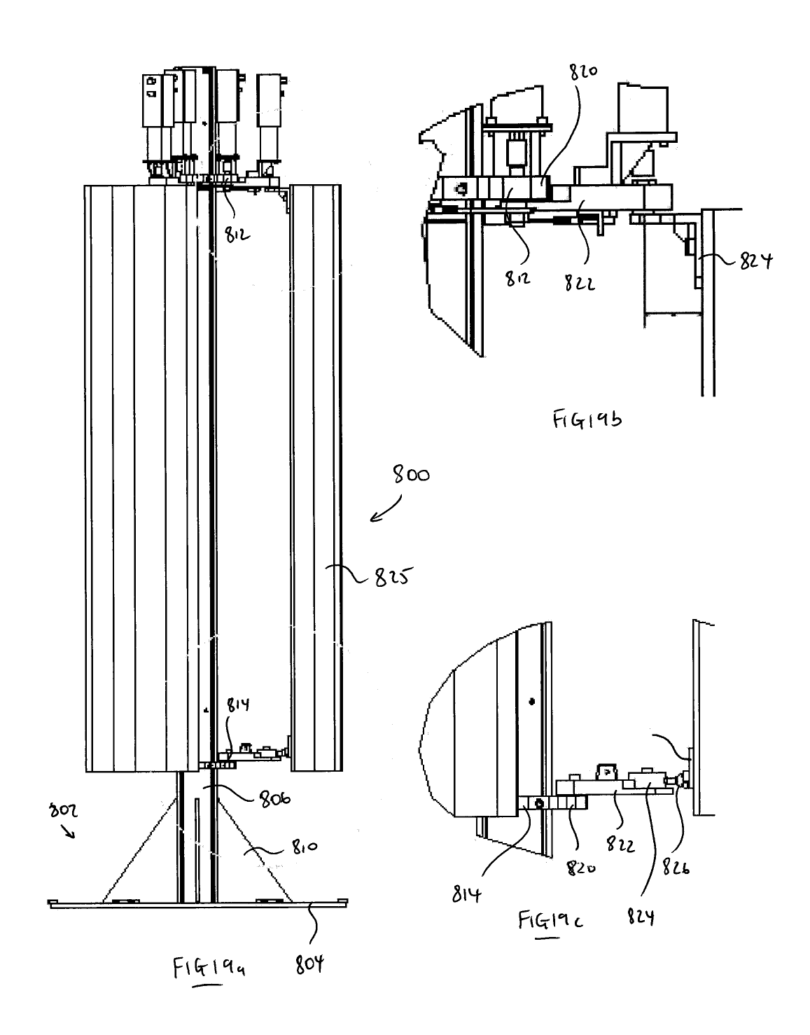

FIG. 17 is a perspective cutaway view of an alternative antenna mounting system in accordance with the present invention;

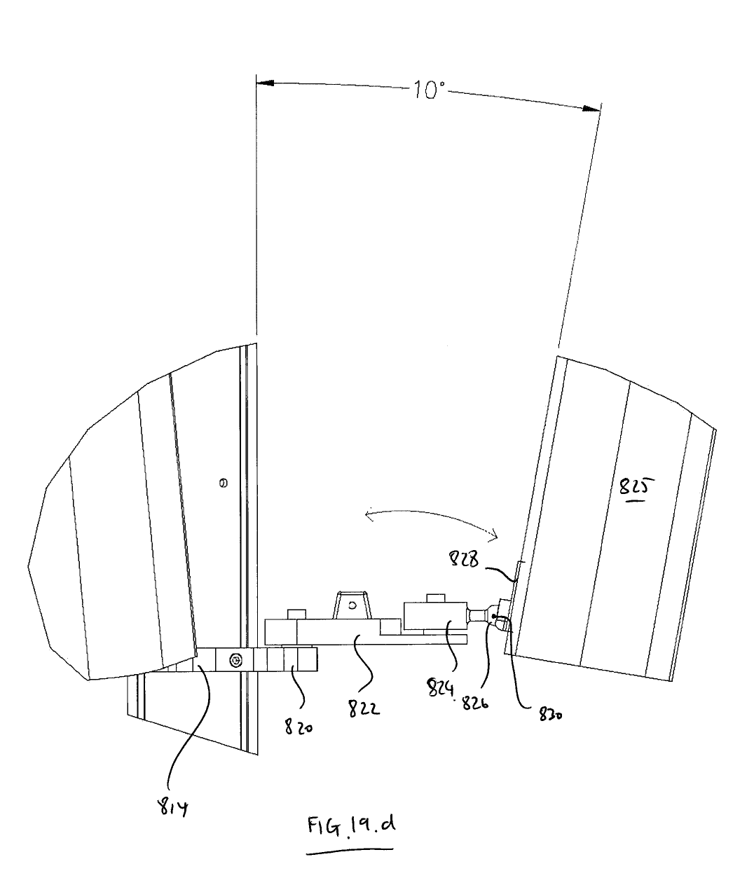

FIG. 18a is a side view of an alternative adjustable antenna mounting system in accordance with the present invention;

FIG. 18b is a detail view of the alternative adjustable antenna mounting system of FIG. 18a;

FIG. 18c is a perspective detail view of the alternative adjustable antenna mounting system of FIG. 18b;

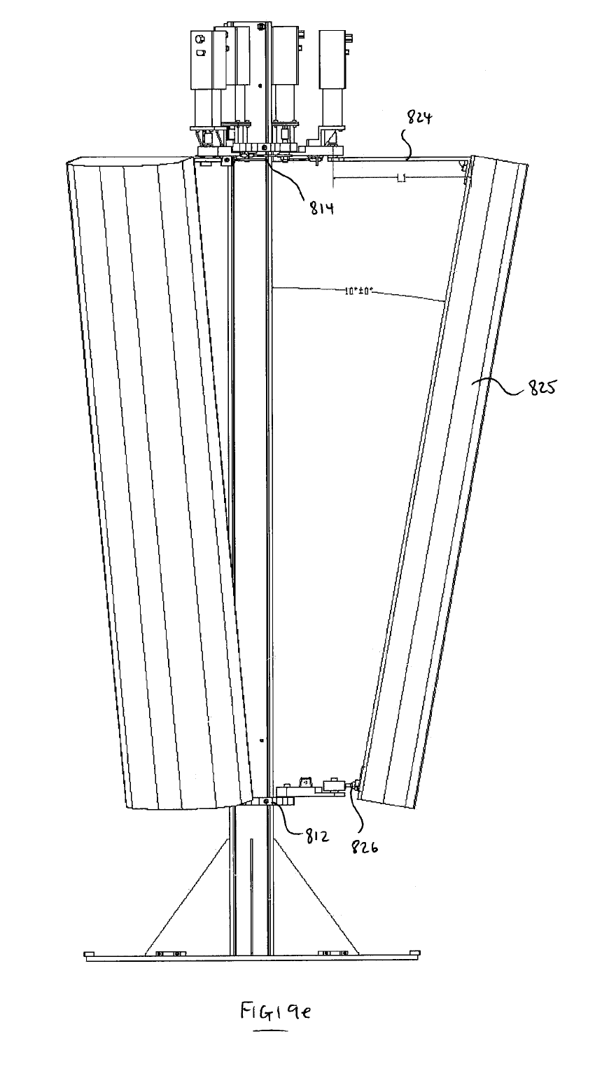

FIG. 19a is a side view of an alternative tiltable antenna mounting system in accordance with the present invention;

FIG. 19b is a detail view of a part of the alternative tiltable antenna mounting system of FIG. 19a;

FIG. 19c is a detail view of a part of the alternative tiltable antenna mounting system of FIG. 19a;

FIG. 19d is a view similar to FIG. 19c in a tilted condition;

FIG. 19e is a side view of the alternative tiltable antenna mounting system of FIG. 19a in a tilted condition;

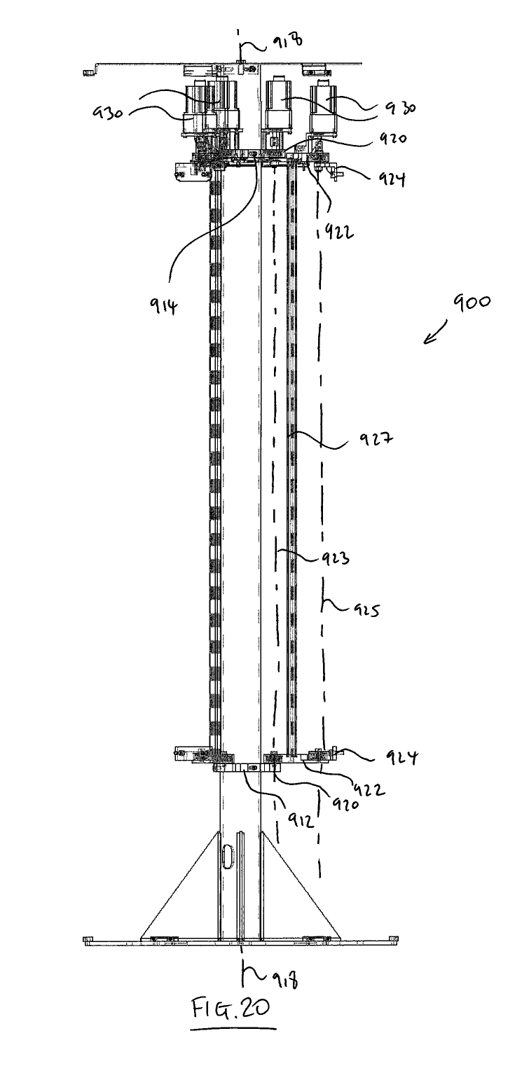

FIG. 20 is a side view of an alternative antenna mounting system without antennas installed, and;

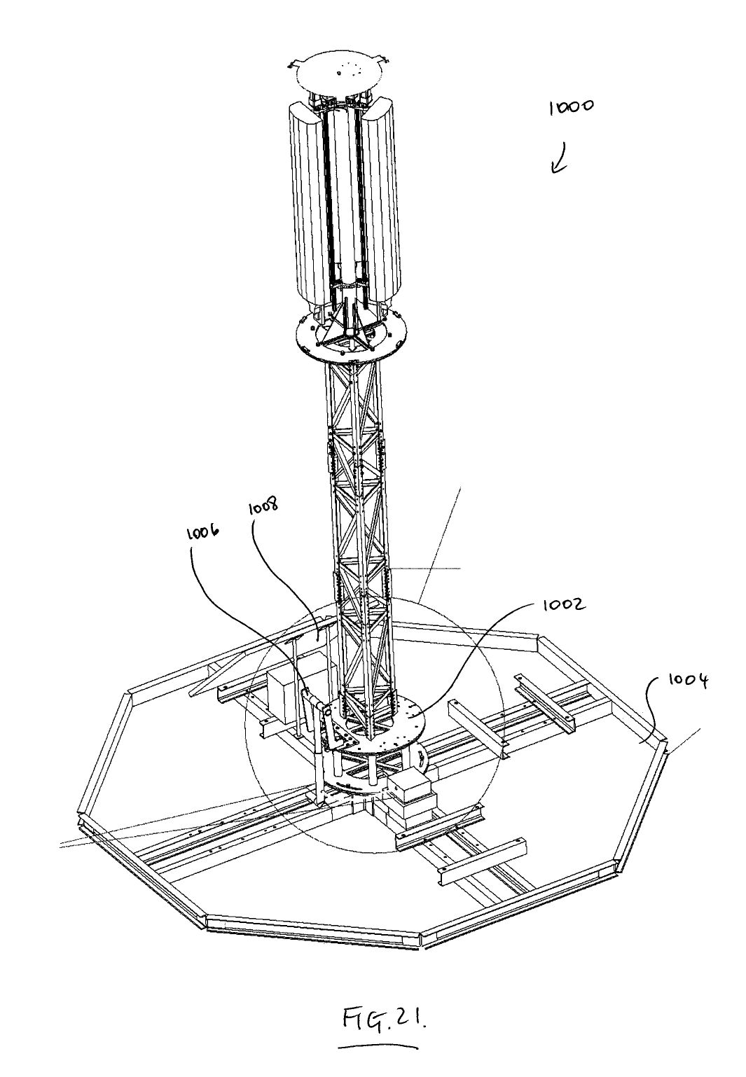

FIG. 21 is a perspective view of an alternative mast assembly.

As shown in FIGS. 1 to 6 there is provided an antenna and mast assembly 100. The assembly comprises a base 102, a mast body 104 and an antenna assembly 106.

The base 102 is generally rotationally symmetric about a central axis P. The base 102 comprises a surface mounting flange 108 which is substantially annular in shape having a number of stiffening ribs 110 spanning the centre thereof. The surface mounting flange has a plurality of holes or preferably slots 113 for attachment to a mounting surface. A top flange 112 is provided, also being annular in shape and comprising stiffening ribs 114. The top flange 112 is offset from the surface mounting flange 108 and supported on a plurality equidistant posts 116 positioned around the circumference of the flanges 108, 112. The top flange 112 defines a number of bores (not visible) through which bolts can be passed.

The mast body 104 comprises a first flange 118 and a second flange 120 offset therefrom. The first flange defines a number equally spaced circle segment slots 121 wide enough to receive the shaft of a bolt. Each of the flanges 118, 120 is annular in shape and comprises a number of stiffening ribs 122, 124 respectively. A truss structure 126 connects the first flange 118 and a second flange 120 to maintain a fixed, parallel distance between the two. The truss structure 126 comprises three uprights 128 joined by three horizontal members 130 midway along their length. Cross-braces 132 span the uprights 128. The triangular cross-sectional shape of the truss structure 126 ensures that buckling is resisted.

The antenna assembly 106 comprises an antenna mounting structure 134 comprising a flange 136 and an upright 138 projecting perpendicularly therefrom. The flange 136 defines an indicator 506 positioned at a predetermined circumferential position as shown in FIG. 2. The indicator 506 is in the form of a radial notch in the flange 136. The upright 138 is connected to the flange 136 via four equally circumferentially spaced corner pieces 140 which are welded into position.

The antenna assembly 106 further comprises an antenna array 142 mounted to the upright 138 as will be described below.

The upright 138 comprises a pair of mounting brackets 150, 152 which are spaced apart along its main axis. Each mounting bracket 150, 152 comprises a collar 154 which surrounds and is attached to the upright 138. Each mounting bracket 150, 152 comprises three equidistantly spaced lugs 154 projecting at 120 degrees to each other. Each lug 154 comprises a through bore 156 as will be described below.

Referring to FIG. 2, the antenna array 142 comprises a first antenna assembly 144, a second antenna assembly 146 and a third antenna assembly 148. Each antenna assembly 144, 146, 148 is equally spaced around the circumference of the upright 138 such that they are in a default position of 120 degrees apart. Thus in the preferred embodiment, the antennae default positions with respect to the central axis are 60, 180 and 300 degrees. The 60 degree position is aligned 60 degrees from the indicator 506.

The antenna assemblies 144, 146, 148 are substantially identical and as such only the antenna assembly 144 will be described in detail here.

The first antenna assembly 144 comprises an intermediate member 158 pivotally attached to the lug 154 to rotate about a first pivot axis 160. The first antenna assembly 144 also comprises an antenna 162 which is pivotally attached to the intermediate member 158 via antenna brackets 159 to rotate about a second axis 164 parallel to the first axis 160.

The first antenna assembly 144 further comprises a first drive assembly 166 and a second drive assembly 168. The first drive assembly 166 comprises a stepper motor 170 having a rotary output shaft 172 extending therefrom. The stepper motor 170 is e.g. a Nanotec™ high torque stepper motor. The stepper motor 170 is mounted to the lug 154 via an ‘L’ shaped bracket 174 such that the axis of rotation of the output shaft 172 is perpendicular to the first pivot axis 160.

A gearbox 176 is connected to the output shaft 172 and drives an input shaft 178 which is fixed to the intermediate member 158. It will be understood that the gearbox 176 is a worm drive gearbox and as such comprises a worm gear attached to the output shaft 172 and a bevel gear engaged with the worm gear and attached to the input shaft 178. As such, the intermediate member 158 can be driven to rotate about the first pivot axis 160 by the stepper motor 170. Advantageously, the worm gear box cannot be easily back driven.

The worm gear box has a reduction gear ratio typically in the order of 60:1. This provides very accurate adjustment of the antenna, particularly combined with a stepper motor with an in-built gear reduction of 100:1.

The second drive assembly 168 is substantially similar to the first drive assembly 166. However it is arranged to drive the antenna 162 rotationally about the second axis 164 relative to the intermediate member 158.

The stepper motors 170 are arranged to provide adjustment in set increments, e.g. 1 degree increments.

Referring now to FIG. 4, a base and mast casing 180 can be placed over the base and mast in order to obscure their appearance and to protect any electrical equipment 182 (see FIG. 3) disposed therein. A cylindrical radome 184 is placed over the antenna assemblies 144, 146, 148 to provide protection from rain/wind etc.

The antenna and mast assembly is assembled and installed as follows.

During manufacture, and before the mast is erected, the antenna assembly 106 is preconfigured (without the antennas). The assembly 106 is configured such that the brackets 159 are each aligned to face 60, 180 and 300 degrees to the indicator 506.

As shown in FIG. 7, the base 102 is attached to a surface 10 such as a building roof or other structure using fasteners 11. The fasteners 11 are heavy duty anchors. During attachment of the base 102 to the surface 10, an adaptor 12 is attached to the base 102. The adaptor comprises a base attachment portion 13, a compass attachment portion 14 and a vertical post 15 therebetween.

A high accuracy compass 16, with an accuracy of at least +/−0.5 degrees (such as the Honeywell™ mu-point gyro-stabilised, digital magnetic compass), is attached to the compass attachment portion 14. The adaptor 12 is configured such that the compass is aligned with an indicator 103 in the form of a notch cut radially into the top flange 112. It will be noted that the compass 16 is installed at a radial distance from the central axis P of the base 102.

The base 102 is rotated about the axis P until the indicator 103 is directed at North (arrow N). It will be noted that the fasteners 11 can be partially installed to permit movement within slots 113 such that fine tuning of the alignment can take place before final tightening.

When the correct orientation is achieved, the adaptor 12 removed. As such, the base 102 is now accurately aligned with a datum (i.e. North).

The mast body 104 is assembled to the desired height. This involves attaching one or more truss structures 126 to the first and second flanges 118, 120. Referring to FIG. 8a, this is achieved via angle-sections 119, 123 projecting from the flanges 118, 120 respectively. The angle-sections 119, 123 engage the uprights 128 and are bolted thereto to secure the flanges 118, 120 in place.

Because of their structure, two (or more) truss structures 326 may be assembled together as shown in FIG. 8b, making a taller mast body 304. The truss structures are secure together using angle-section pieces 306 which are bolted to the respective uprights 328 of the truss structures.

Each of the flanges 118, 120 comprises an indicator 500, 502 respectively placed at a predetermined position on its circumferential edge. The indicators 500, 502 are radial notches. It is very important that the indicators 500, 502 are aligned to the same circumferential position for reasons which will be explained below.

The flange 136 of the antenna assembly 106 is attached to the flange 120 of the mast body 104 such that the respective indicators 506, 502 are aligned.

The top flange 112 of the base 102 mast body 104 is assembled to the first flange 118 of the mast body 104 via a hinge 186 (see FIG. 10) to pivot about an erection axis T. As shown in FIGS. 7 and 10, the indicators 103, 500 of the flanges 112, 118 respectively are both positioned opposite (i.e. at 180 degrees to) the hinge 186.

The mast body 104 and antenna assembly 106 are rotated about the erection axis T through the intermediate position shown in FIG. 8b to the erect position shown in FIG. 8c at which point the mast body 104 is perpendicular to the ground, and the top flange 112 and the first flange 118 are in contact per FIG. 9.

Once the mast body 104 is in this position, bolts 187 are used to secure the flanges 112, 118 together, and the hinge 186 is removed as shown in FIG. 11.

It will be noted that in the final assembled condition, the 60 degree bracket 159, being aligned 60 degrees from the indicator 506, is also aligned at 60 degrees to indicators 502, 500 and 103. As indicator 103 was aligned with North, the 60 degree bracket 159 will point 60 degrees from North.

In use, the mast assembly 100 will be provided and installed without the antennae 162. Because of the aforementioned, accurate alignment during erection of the mast, and the pre-assembly of the antenna assembly 106, the service provider will not need to manually align or measure the azimuth of the antenna. They will know that the alignment is 60, 180, 300 degrees with respect to North and can use the aforementioned control system to direct the antennae as required.

Referring to FIGS. 12a and 12b, FIG. 11a shows the antenna assemblies 144, 146, 148 in their default or nominal position wherein each antenna is 120 degrees apart. Referring to FIG. 12b, the antennas of the antenna assemblies 146, 148 have been rotated about both the pivot axis 160 and the pivot axis 164 such that the antennas point in substantially the same direction. This is achieved by the sequence of movements about the two axes 160, 164 as shown in FIGS. 13a to 13j. In particular, it can be seen that the intermediate members 158 move approximately 18 degrees towards each other (i.e. a movement of 9 degrees each) in order to facilitate this movement.

An optical encoder (not shown) is provided in order to assess the position of each of the antennae in use. The optical encoder is connected, via a control system, to the stepper motors 170 in order to provide accurate positional control. The accuracy of optical encoders known in the art is less than 0.002 degrees. Therefore, because the mast system has been accurately aligned with respect to North (using the set up procedure described herein), the provider can easily direct the antennas in the desired direction.

A control system is provided which is used to control the position of the antennas. The control system is a computer-based system in which control software is installed onto the memory of a computer having a processor, an output to the motors 170 and an input from the optical encoders. A remote user inputs the desired azimuth angle of the antenna with respect to the initial angle (60, 180, 300 degrees). The computer then sends an output to the stepper motor 170 to move towards that azimuth angle. The computer monitors the movement of the antenna using data from the optical encoder to determine the true position of the encoder. The control system therefore uses a feedback loop to adjust the antenna to the desired position.

In a three antenna arrangement (as shown), for it to be possible for any two antennas to point in the same direction they must have a total movement range of 120 degrees. Specifically, as is shown in FIG. 13j, each antenna moves 60 degrees towards the other. This movement comprises a 51 degree rotational movement of the antenna relative to the intermediate member 158 about the axis 164, and a 9 degree rotational movement of the intermediate member relative to the upright 138 about the axis 160. It will be noted that this movement is possible in two opposite directions about the axes 160, 164 and as such each antenna is capable of a 120 degree motion (i.e. 60 degrees about its default position).

The 9 degree motion on one axis and 51 degree motion on the other axis has been calculated for antenna dimensions that have a pre-determined maximum width & depth. This means that the antennas do not clash when pointing in the same direction (i.e. one antenna at +60 degrees, the another at −60 degrees) Specifically, these angles allow a width equal to or less than 270 mm and a depth equal to or less than 120 mm.

It is noted that central pole, or upright 138, on which the antenna assemblies 144, 146 and 148, are mounted have a predetermined diameter according to a static study for the weight load that it is intended to carry. Heavier antenna will require larger diameter poles compared to those needed for lighter antenna. Typically the pole is made of aluminium.

It is envisaged that other combinations of these angles are possible (providing they amount to 60 degrees of total rotation in either direction). A 15/45 split is appropriate to allow a width equal to or less than 170 mm and a depth equal to or less than 85 mm. The minimum permissible distance to the radome must also be accounted for.

As such, the present invention provides a compact antenna assembly 106 in which two antennas can be pointed in the same direction.

Referring to FIG. 14, an alternative antenna assembly 200 is shown in which a plurality of identical mast bodies 104 are attached to each other using their complementary mating formations. The antenna assembly 106 is placed on top. A plurality of guide wires 202 are used to hold the mast in place and attached to ground support members 204.

Referring to FIG. 15, instead of the electronic actuation as described in the above embodiment, the rotational position of an antenna 444 relative to an intermediate member 458 is manually set. The position of the intermediate member 458 relative to the lug 154 is also manually set. Handles 490, 491 can be tightened and loosened to allow manual rotation of the antenna 444 and intermediate member 458.

An electrical potentiometer such as a Single Turn Wirewound, Bushing Mount Type potentiometer manufactured by Vishay™ can be used to provide feedback to a computer connected to a display to allow the user to determine when the desired position with respect to the original position (i.e. 60, 180 or 300 degrees) is reached. Alternatively the output from the electrical potentiometers can be monitored remotely whilst the technician is remotely instructed.

It will be noted that a manual system could be used for one axis, and the automated system for another axis. In this case, the output from the electrical potentiometers of the manual part of the system will input into the control system of the automatic part, so that the absolute position of the antennas with respect to the datum will still be known by the control system. In other forms an electrical motor, such as stepper motor, is used to provide crude initial rotational settings and/or final fine settings for rotation about one or both of the axes 160 and 164. In a preferred form the movement about each axis is completed electronically using an electrical control such as a switch that feeds back to the control system and enables rotational control of the electrical drive motors in either direction. Alternatively, where the control system comprises a computer, the rotational control might be via a graphical user interface on a display enabling the user to select the appropriate motor and adjust rotation according to a feedback signal.

Differing mating formations may be provided on each of the flanges 118, 120 of the mast bodies. In this way they can still be interconnected.

Alternatively, a different number of antenna assemblies may be provided about a central axis in order to provide the above required functionality.

Further links may be provided to allow further degrees of freedom of movement of the antennas. For example, a further intermediate member may be provided between the intermediate member and the antenna.

The antenna may be installed in a vehicle, and a hinge mechanism positioned midway along the mast in order to permit deployment and stowage for transport as shown in FIGS. 16a and 16b.

Referring to FIG. 17, an alternative antenna assembly 600 is provided. The antenna assembly 600 comprises an antenna mounting structure 602 comprising a flange 604 and an upright 606 projecting perpendicularly therefrom. The flange 606 defines an indicator 608 positioned at a predetermined circumferential position. The indicator 608 is in the form of a radial notch in the flange 604. The upright 606 is connected to the flange 604 via four equally circumferentially spaced corner pieces 610 which are welded into position.

The antenna assembly 600 further comprises a first antenna array 612 and a second antenna array 614 mounted to the upright 606.

Each array 612, 614 is similar to the array 142 and as such they will not be described in detail. It will be noted that the arrays 612, 614 are independently operable. Therefore antennae in the array 612 can be directed independently to the array 614. In this way, each of the arrays can be used to provide coverage for different providers or different data signal types without the need for complex site sharing techniques and without having to compromise on the ideal antenna position.

Referring to FIGS. 18a to 18c, an alternative antenna assembly 700 is provided. The antenna assembly 700 comprises an antenna mounting structure 702 comprising a flange 704 and an upright 706 projecting perpendicularly therefrom. The upright 706 is connected to the flange 704 via four equally circumferentially spaced corner pieces 710 which are welded into position.

The antenna assembly 700 is similar to the antenna assembly 106. Two mounting brackets 712, 714 are provided which are spaced vertically along a longitudinal axis 718. The bracket 714 is fixed to the upright 706, but the bracket 712 is slidable along the upright 706 along the axis 718.

As with the antenna assembly 106, the brackets 712, 714 each comprises three lugs 720 to each of which an intermediate member 722 is pivotally attached. Antenna mounting flanges 724 are pivotally attached to each intermediate member 722.

Therefore the mounting bracket 712 can be moved up and down the upright 706 in order to cater for antennas of different lengths.

In order to maintain angular alignment between the brackets 712, 714, alignment slide rails 726 are provided which extend between the brackets 712, 714. Each alignment slide rail 726 passes through the intermediate member 722 and extends parallel to the axis 718. Each intermediate member 722 can slide along the relevant slide rail as the bracket 712 is moved towards and away from the bracket 714. Because the slide rails 726 are spaced from the main axis 718 (being the axis of rotation of the brackets 712, 714), angular alignment of the brackets 712, 714 is maintained. Grub screws 728 are passed through lugs 720 extending from the intermediate members to secure the bracket 702 once in the desired position.

Turning to FIGS. 19a to 19e, an alternative antenna assembly 800 is provided. The antenna assembly 800 comprises an antenna mounting structure 802 comprising a flange 804 and an upright 806 projecting perpendicularly therefrom. The upright 806 is connected to the flange 804 via four equally circumferentially spaced corner pieces 810 which are welded into position.

The antenna assembly 800 is similar to the antenna assembly 106. Two mounting brackets 812, 814 are provided which are spaced vertically along a longitudinal axis 718.

As with the antenna assembly 106, the brackets 812, 814 each comprises three lugs 820 to each of which an intermediate member 822 is pivotally attached. Antenna mounting components 824 are pivotally attached to the intermediate members 822. Three antennas 825 are connected at each end to the antenna mounting components 824.

The antenna mounting components 824 mounted to the intermediate members 822 of the first bracket 812 differ from those mounted to the intermediate members 822 of the second bracket 814. The lower antenna mounting components 824 comprise a ball joint 826 which provides the ability of an antenna mounting flange 828 to pivot about an axis 830 perpendicular to the main axis of the antenna (and perpendicular to the page of FIG. 19d).

Therefore, as shown in FIG. 19e, a longer antenna mounting component 824 can be used proximate the bracket 814 to provide a downward tilt to the antenna 825.

It is within the scope of the present invention to use e.g. a linear actuator to provide automated tilt control in place of the upper antenna mounting component 824.

Referring to FIG. 20, an alternative antenna assembly 900 is shown. Two mounting brackets 912, 914 are provided which are spaced vertically along a longitudinal axis 918.

As with the antenna assembly 106, the brackets 912, 914 each comprises three lugs 920 to each of which an intermediate member 922 is pivotally attached to rotate about a first axis 923. Antenna mounting components 924 are pivotally attached to the intermediate members 922 to rotate about a second, parallel axis 925. The antenna mounting components 924 are configured to receive antennas.

A stability rail 927 is attached at each end to the intermediate members 922. The rail 927 provides stability between the intermediate members, and acts as a load path to transfer torque to the lower intermediate member 922.

It will also be noted that a set of six actuators 930 are oriented vertically, and as such require no worm gear arrangement to transfer drive to the intermediate members 922 and the antenna mounting components 924.

The base 102 may be provided with a power source for the antennas and/or the actuators. This may take the form of photovoltaic cells, batteries, a wind turbine or the like. Referring to FIG. 21, a mast assembly 1000 is provided which comprises a mast assembly 100 similar to that of the mast assembly 100, but a base 1002 comprises a wide base plate 1004 being of significant surface area. As such, the base plate 1004 provides stability without the need to use fasteners to attach the base 1002 to a ground surface.

The base plate 1004 comprises a hydraulic hinge 1006 which can raise and lower the mast as well as a photovoltaic solar panel 1008 connected to a series of cells for the collection and storage of energy to power the mast systems.

1-44. (canceled)

45. A cellular communications antenna mounting assembly comprising;
a central pole having a main pole axis,
a pair of mounting brackets, each comprising a collar to receive the pole and spaced apart along the main pole axis,
a plurality of mounting apparatuses spaced around the central pole, each comprising:
an intermediate member pivotally attached to each mounting bracket to pivot about a first axis, and,
an antenna bracket pivotally attached to the intermediate member to pivot about a second axis substantially parallel to the first axis.

46. A cellular communications antenna mounting assembly according to claim 45 in which each mounting apparatus comprises:
a first actuator configured to pivot the intermediate member about the first axis relative to the central antenna mount, and
a second actuator configured to pivot the antenna bracket about the second axis relative to the intermediate member.

47. A cellular communications antenna mounting assembly according to claim 46 in which the first actuator comprises a rotary output shaft oriented perpendicular to the first axis, the apparatus comprising a gearbox between the rotary output shaft and the intermediate member to transfer drive from the rotary shaft to the intermediate member.

48. A cellular communications antenna mounting assembly according to claim 46 in which the second actuator comprises a rotary output shaft oriented perpendicular to the second axis, the apparatus comprising a gearbox between the rotary output shaft and the antenna to transfer drive from the rotary shaft to the antenna bracket.

49. A cellular communications antenna mounting assembly according to claim 47 in which the gearbox comprises a worm gear, in which the worm gear is connected to the rotary output shaft and drives a bevel gear connected to the intermediate member and/or antenna bracket.

50. A cellular communications antenna mounting assembly according to claim 46 in which the actuators are stepper motors.

51. A cellular communications antenna mounting assembly according to claim 50 in which each mounting apparatus comprises an optical encoder arranged to provide a signal representative of the angular position of the intermediate member and/or antenna bracket.

52. A cellular communications antenna mounting assembly according to claim 51 comprising a control system configured to adjust the position of the antenna bracket using the actuators based on an output from the optical encoder.

53. A cellular communications antenna mounting assembly according to claim 45 in which each apparatus comprises an optical potentiometer arranged to provide a signal representative of the angular position of the intermediate member and/or antenna bracket.

54. A cellular communications antenna mounting assembly according to claim 53 in which the signal is linked to a display to enable a technician to manually position the antenna bracket.

55. A cellular communications antenna mounting assembly according to claim 53 comprising:
a first securing mechanism configured to selectively inhibit relative movement of the intermediate member about the first axis relative to the antenna mount, and
a second securing mechanism configured to selectively inhibit relative movement of the antenna bracket about the second axis relative to the intermediate member.

56. A cellular communications antenna mounting assembly according to claim 45 comprising an antenna attached to the antenna bracket.

57. A cellular communications antenna mounting assembly according to claim 45 comprising three antenna mounting apparatuses spaced 120 degrees apart about the central antenna mount.

58. A cellular communications antenna mounting assembly according to claim 57 in which each of the antenna brackets has a range of motion of +/−60 degrees.
